(19) United States
(12) Patent Application Publication
(10) Pub. No.: US 2019/0122627 A1
(43) Pub. Date: Apr. 25, 2019

(54) DISPLAY DEVICE AND METHOD OF DRIVING THE SAME

(71) Applicant: Samsung Display Co., Ltd., Yongin-Si (KR)

(72) Inventors: JONGMAN KIM, Seoul (KR); DONG-HYUN YEO, Yongin-si (KR); WOOJUNG JUNG, Hwaseong-si (KR); YONG-BUM KIM, Suwon-si (KR); YONGHO SUNG, Seongnam-si (KR); BYUNGKIL JEON, Hwaseong-si (KR)

(21) Appl. No.: 16/152,815

(22) Filed: Oct. 5, 2018

(30) Foreign Application Priority Data
Oct. 23, 2017 (KR) 10-2017-0137777

(51) Int. Cl. G09G 3/36

(52) U.S. Cl. CPC G09G 3/3677; G09G 2340/16; G09G 2320/0285; G09G 3/3688

(57) ABSTRACT

A display device includes a display panel and a display panel driver. The display panel driver includes an over-driver which selects an over-driving data from an over-driving pattern which moves to a predetermined direction, generates a reference line based on a first polynomial expression generated based on the over-driving data, and generates an over-driving data lookup table by moving the reference line, a data driver which outputs a data signal generated based on the over-driving data lookup table to the data line of the display panel, and a gate driver which outputs a gate signal to the gate line of the display panel.

This application claims priority to Korean Patent Application No. 10-2017-0137777, filed on Oct. 23, 2017, and all the benefits accruing therefrom under 35 U.S.C. § 119, the content of which in its entirety is herein incorporated by reference.

### BACKGROUND

### 1. Technical Field

Exemplary embodiments relate generally to a display device. More particularly, exemplary embodiments of the inventive concept relate to a display device and a method of driving the same.

### 2. Description of the Related Art

A liquid crystal display panel of a liquid crystal display device generally includes a lower substrate, an upper substrate, and a liquid crystal layer interposed between the lower substrate and the upper substrate.

The lower substrate generally includes a first base substrate, a gate and a data line formed on the first based substrate, a switching element electrically coupled to the gate line and the data line, and a pixel electrode electrically coupled to the switching element.

The upper substrate generally includes a second base substrate facing the first substrate, a color filter formed on the second base substrate, and a common electrode formed on the color filter.

The liquid crystal layer generally includes a liquid crystal of which an arrangement is changed according to an electric field due to a pixel voltage applied to the pixel electrode and a common voltage applied to the common electrode.

In order to increase a response speed of the liquid crystal, the liquid crystal display panel may be driven in a Dynamic Capacitance Compensation (“DCC”) method according to previous frame data and present frame data.

### SUMMARY

Some exemplary embodiments provide a display device capable of improving display quality.

Some exemplary embodiments provide a method of driving a display device capable of improving display quality.

According to an exemplary embodiment, a display device includes a display panel which includes data lines and gate lines, and a display panel driver which drives the display panel. The display panel driver includes an over-driver which selects an over-driving data from an over-driving pattern which moves to a predetermined direction, generates a reference line based on a first polynomial expression generated based on the over-driving data, and generates an over-driving data lookup table by moving the reference line, a data driver which outputs a data signal generated based on the over-driving data lookup table to the data line of the display panel, and a gate driver which outputs a gate signal to the gate line of the display panel.

In exemplary embodiments, the over-driver may include a pattern generator which generates the over-driving pattern which includes previous frame data and present frame data having different grayscales, where the over-driving pattern includes a transit area where the previous frame data is changed to the present frame data, a first memory which receives the over-driving data which offsets the transit area and store the over-driving data, a first calculator which calculates parameters of the first polynomial expression based on the over-driving data and generates the reference line based on the first polynomial expression, a second calculator which calculates a moving amount of the reference line based on the over-driving data and generates the over-driving data lookup table by moving the reference line as the moving amount, and a second memory which stores the over-driving lookup table.

In exemplary embodiments, the first calculator may calculate the parameters of the first polynomial expression of DOD−DPF=A(DCF)³+B(DCF)²+C(DCF)+D, based on the over-driving data and generate the reference line based on the first polynomial expression, where DOD is the over-driving data, DPF is the previous frame data, DCF is the present frame data, and A, B, C, D are the parameters of the first polynomial expression.

In exemplary embodiments, the second calculator may calculate the over-driving data lookup table based on the second polynomial expression of DOD−DPF=A(DCF−Δx)³+B(DCF−Δx)²+C(DCF−Δx)+D, where Δx is the moving amount.

In exemplary embodiments, the pattern generator may generate a first over-driving pattern which includes the previous frame data having a reference grayscale and the present frame data having a first grayscale, and a second over-driving pattern which includes the previous frame data having the reference grayscale and the present frame data having a second grayscale.

In exemplary embodiments, the first memory may store a first over-driving data selected when the first over-driving pattern is displayed on the display panel, and a second over-driving data selected when the second over-driving pattern is displayed on the display panel.

In exemplary embodiments, a first calculator may calculate parameters of the first polynomial expression based on a first over-driving data, a second over-driving data, a predetermined first default data, and a predetermined second default data.

In exemplary embodiments, the predetermined first default data may be the over-driving data selected when the over-driving pattern which includes the previous frame data and present frame data having the same reference grayscale is displayed on the display panel.

In exemplary embodiments, the predetermined second default data may be the over-driving data selected when the over-driving pattern which includes previous frame data having a reference grayscale and present frame data having a maximum grayscale is displayed on the display panel.

In exemplary embodiments, the pattern generator may further generate a third over-driving pattern which includes the previous frame data having a third grayscale and the present frame data having a fourth grayscale.

In exemplary embodiments, the first memory may store a third over-driving data selected when the third over-driving pattern is displayed on the display panel, and the second calculator may calculate the moving amount based on the third over-driving data.

In exemplary embodiments, the over-driving data may be selected by a user.

In exemplary embodiments, the over-driving data may be input in a manufacturing process.

According to an exemplary embodiment, a method of driving a display device includes displaying an over-driving pattern which moves to a predetermined direction on a display panel, selecting an over-driving data which offsets a transit area of the over-driving pattern, generating a reference line based on a first polynomial expression generated based on the over-driving data, generating an over-driving data lookup table by moving the reference line and a step of storing the over-driving data lookup table.

In exemplary embodiments, the over-driving pattern may include previous frame data and present frame data having different grayscales, and the over-driving pattern may include the transit area where a previous frame data is changed to a present frame data.

In exemplary embodiments, parameters of the first polynomial expression of DOD−DPF=A(DCF)³+B(DCF)²+C(DCF)+D, may be calculated based on the over-driving data, where DOD is the over-driving data, DPF is previous frame data, DCF is present frame data, and A, B, C, D are parameters and the reference line may be generated based on the first polynomial expression.

In exemplary embodiments, the over-driving data lookup table may be generated based on a second polynomial expression of DOD−DPF=A(DCF−Δx)³+B(DCF−Δx)²+C(DCF−Δx)+D, where Δx is a moving amount.

In exemplary embodiments, the method of driving a display device may further include generating the over-driving pattern which may include generating a first over-driving pattern which includes previous frame data having a reference grayscale and present frame data having a first grayscale, generating a second over-driving pattern which includes the previous data having the reference grayscale and the present frame data having a second grayscale, and generating a third over-driving pattern which includes the previous data having a third grayscale and the present frame data having a fourth grayscale.

In exemplary embodiments, selecting the over-driving data may include selecting the first over-driving data when the first over-driving pattern is displayed on a display panel, selecting the second over-driving data when the second over-driving pattern is displayed on the display panel, and selecting the third over-driving data when the third over-driving pattern is displayed on the display panel.

In exemplary embodiments, parameters of the first polynomial expression may be calculated based on the first over-driving data, the second over-driving data, a predetermined first default data, and a predetermined second default data, and a moving amount of the reference line may be determined based on the third over-driving date.

Therefore, a display device and a method of driving the same may provide an image having high display quality by displaying an over-driving pattern on a display panel, selecting an over-driving data which offsets a transit area of the over-driving pattern, and generating an over-driving data lookup table based on the over-driving data. Further, an addition device is not required in a manufacturing process because the over-driving data lookup table is generated based on an algorithm using the over-driving pattern. A time for setting the over-driving data lookup table may be reduced. Further, the high quality image may be provided to the user because the user select the over-drive data.

### BRIEF DESCRIPTION OF THE DRAWINGS

Illustrative, non-limiting exemplary embodiments will be more clearly understood from the following detailed description taken in conjunction with the accompanying drawings.

FIG. 1 is a block diagram illustrating an exemplary embodiment of a display device according to the invention.

FIG. 2 is a block diagram illustrating an exemplary embodiment of an over-driver included in the display device of FIG. 1.

FIG. 3 is diagram illustrating an exemplary embodiment of an over-driving pattern for describing an operation of a pattern generator included in the over-driver of FIG. 2.

FIG. 4 is a diagram illustrating a difference between over-driving data and previous frame data versus a present frame data for describing a first calculator included in the over-driver of FIG. 2.

FIGS. 5A and 5B are graphs illustrating a difference between over-driving data and previous frame data versus a present frame data for describing an operation of a second calculator included in the over-driver of FIG. 2.

FIG. 6 is an over-driving data lookup table for describing an operation of a second calculator included in the over-driver of FIG. 2.

FIG. 7 is a flowchart illustrating an exemplary embodiment of a method of driving a display device according to exemplary embodiments.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, the inventive concept will be explained in detail with reference to the accompanying drawings.

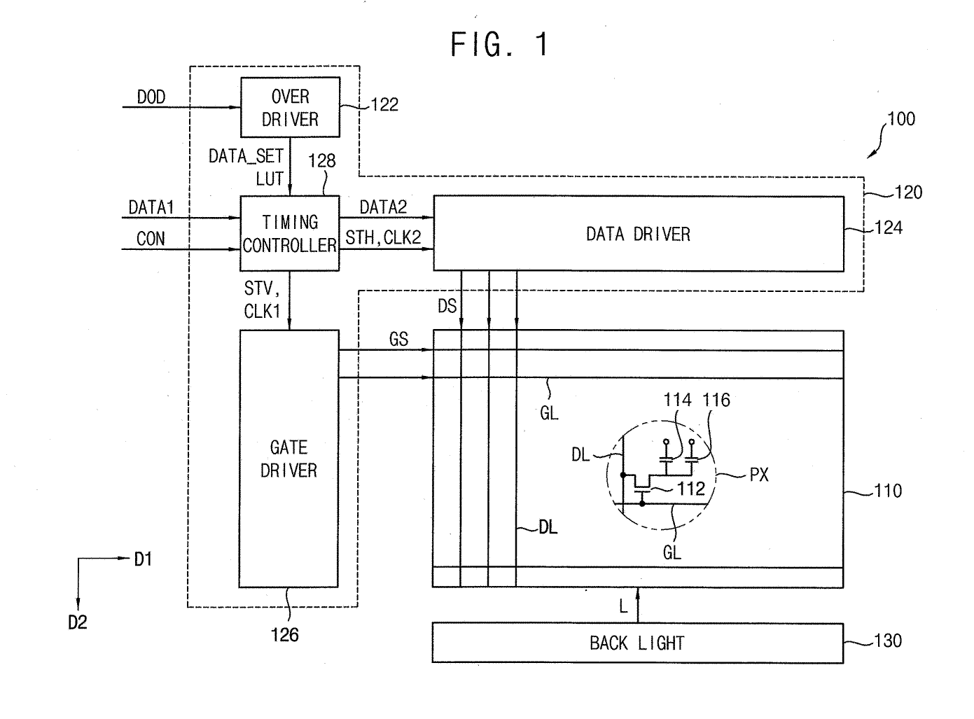

FIG. 1 is a block diagram illustrating an exemplary embodiment of a display device according to the invention.

Referring FIG. 1, a display device 100 may include a display panel 110 and a display panel driver 120.

The display panel 110 may include data lines DL, gate lines GL, and a plurality of pixels PX. The gate lines GL may extend in a first direction D1 and be arranged in a second direction D2 substantially perpendicular to the first direction D1. The data lines DL may extend in the second direction D2 and be arranged in the first direction D1. The first direction D1 may be parallel with a long side of the display panel 110, and the second direction D2 may be parallel with a short side of the display panel 110. Each of the pixels PX may be arranged in an intersection region of the data line DL and the gate line GL. Each of the pixels PX includes a thin film transistor 112 electrically coupled to the gate line GL and the data line DL, a liquid crystal capacitor 114 and a storage capacitor 116 coupled to the thin film transistor 112. Thus, the display panel 110 may be a liquid crystal display panel, and the display device 100 may be a liquid crystal display apparatus.

The display panel driver 120 may include an over-driver 122, a data driver 124, a gate driver 126, and a timing controller 128.

The display panel driver 120 may provide a data signal DS and a gate signal GS in order to drive the display panel 110 to the data line DL and the gate line GL in the display panel 110, respectively.

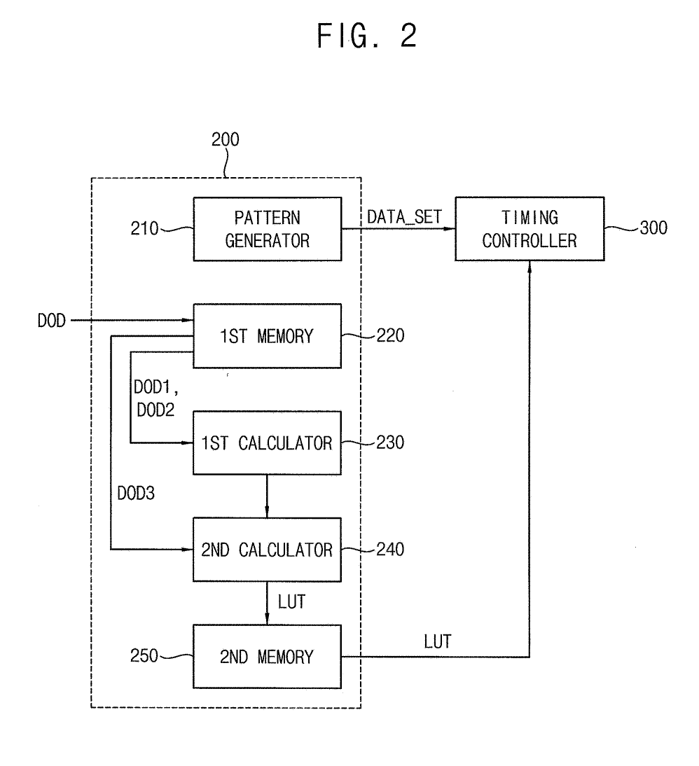

The over-driver 122 may select an over-driving data DOD from an over-driving pattern that moves to a predetermined direction, generate a reference line based on a polynomial expression generated based on the over-driving data DOD, and generate an over-driving data lookup table LUT by moving the reference line. The over-driver 122 may generate the over-driving pattern and provide an over-driving image data DATA SET corresponding to the over-driving pattern to the timing controller 128. The over-driver 122 may receive the over-driving data DOD that offsets a transit area of the over-driving pattern and generate the over-driving data lookup table LUT based on the over-driving data DOD. Hereinafter, a method of generating the over-driving data lookup table LUT in the over-driver 122 will be described in detail referring to FIG. 2. In some exemplary embodiments, the over-driver 122 may be located in the timing controller 128. In this case, the timing controller 128 may generate the over-driving data lookup table LUT using a micro controller unit (“MCU”), and store the over-driving data lookup table LUT in a memory included in the timing controller 128. In other exemplary embodiments, the over-driver 122 may be located in a graphic controller. In this case, the graphic controller may generate the over-driving data lookup table LUT using a graphic process unit (“GPU”), and store the over-driving data lookup table LUT in a graphic memory included in the graphic controller.

The data driver 124 may output the data signal DS corresponding to a second image data DATA2 to the data line DL in response to a horizontal start signal STH and a second clock signal CLK2 provided from the timing controller 128.

The gate driver 126 may generate the gate signal GS in response to a vertical start signal STV and a first clock signal CLK1 and output the gate signal to the gate line GL.

The timing controller 128 may receive a first image data DATA1 and a control signal CON from an external device. The control signal CON may include a horizontal synchronization signal, a vertical synchronization signal, and clock signal. The timing controller 128 may generate the horizontal start signal STH using the horizontal synchronization signal, and provide the horizontal start signal STH to the data driver 124. Further, the timing controller 128 may generate the vertical start signal STV using the vertical synchronization signal, and provide the vertical start signal STV to the gate driver 126. Further, the timing controller 128 may generate the first clock signal CLK1 and the second clock signal CLK2 using the clock signal included in the control signal CON. The timing controller 128 may provide the first clock signal CLK1 to the gate driver 126 and the second clock signal CLK2 to the data driver 124.

Further, the timing controller 128 may receive the over-driving data lookup table LUT from the over-driver 122. The timing controller 128 may convert the first image data DATA1 to the second image data DATA2 by performing a dynamic capacitance compensation using the over-driving data lookup table LUT and provide the second image data DATA2 to the data driver 124.

Further, the timing controller 128 may receive the over-driving data DOD corresponding to the over-driving pattern from the over-driver 122 and provide the over-driving data DOD to the data driver 124.

The display device 100 may further include a light source unit that provides light to the display panel 110. In an exemplary embodiment, for example, the light source may include a light emitting diode.

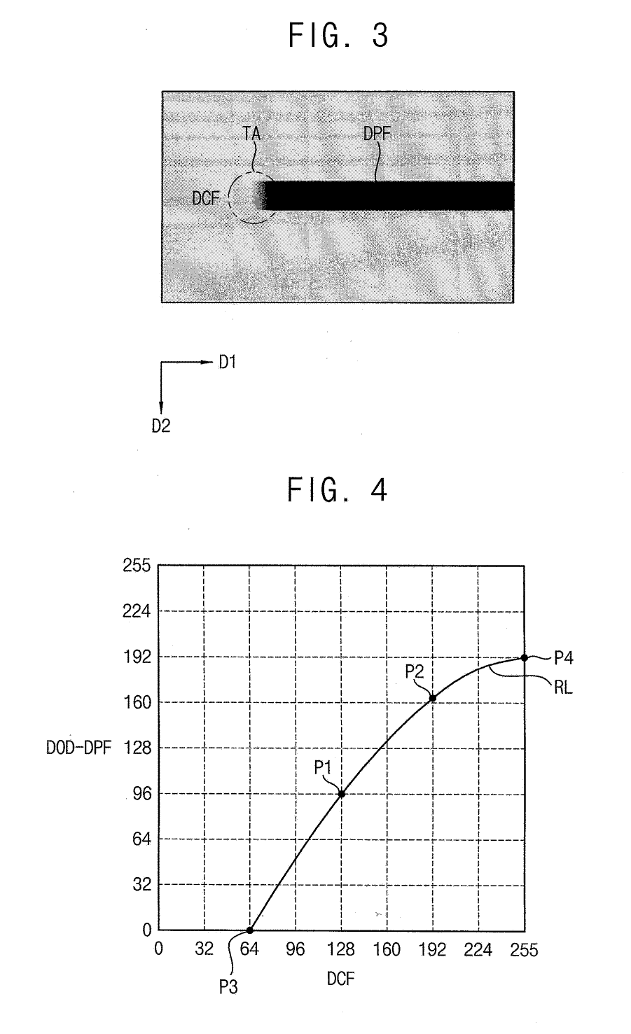

FIG. 2 is a block diagram illustrating an exemplary embodiment of an over-driver included in the display device of FIG. 1, and FIG. 3 is diagram illustrating an exemplary embodiment of an over-driving pattern for describing an operation of a pattern generator included in the over-driver of FIG. 2.

Referring to FIG. 2, an over-driver 200 may include a pattern generator 210, a first memory, a first calculator 230, a second calculator 240, and a second memory 250.

The pattern generator 210 may generate an over-driving pattern that includes a previous frame data DPF and a present frame data DCF having different grayscales. The over-driving pattern may include a transit area TA where the previous frame data DPF is changed to the present frame data DCF. Referring to FIG. 3, the pattern generator 210 may generate the over-driving pattern in order to set over-driving data. The over-driving pattern may have a rectangle shape as described in FIG. 3. Here, a height of the square may be determined considering a contrast sensitivity function (“CSF”). Although the over-driving pattern having the rectangle shape is described in FIG. 3, a shape of the over-driving pattern according to the invention is not limited thereto. In an exemplary embodiment, for example, the over-driving pattern may have a polygon shape or a circular shape. The over-driving pattern may be a scroll pattern that moves to a predetermined direction at a steady speed. Although the over-driving pattern that moves to the first direction D1 is described in FIG. 3, a moving direction of the over-driving pattern according to the invention is not limited thereto. In an exemplary embodiment, for example, the over-driving pattern may move to the second direction D2 or a diagonal direction between the first direction D1 and the second direction D2.

The over-driving pattern may include the previous frame data DPF and the present frame data DCF having different grayscales. In an exemplary embodiment, for example, the over-driving pattern may include the previous frame data DPF having a first grayscale and the present frame data DCF having a second grayscale. The transit area TA having a grayscale between the first grayscale and the second grayscale may occur because of a relatively low response speed of liquid crystal when the previous frame data DPF having the first grayscale is changed to the present frame data DCF having the second grayscale. The pattern generator 210 may provide an over-driving image data DATA SET corresponding to the over-driving pattern to the timing controller 300. The pattern generator 210 may generate at least three over-driving patterns. In an exemplary embodiment, for example, the pattern generator 210 may generate a first over-driving pattern, a second over-driving pattern, and a third over-driving pattern.

In some exemplary embodiments, a user may change data of the transit area TA and may select the over-driving data DOD that offsets the transit area TA. That is, a frame data corresponding to the transit area TA may be inserted between the previous frame data DPF and the present frame data DCF. The user may select the over-driving data DOD that offsets the transit region TA by changing a grayscale of the frame data. The over-driving data DOD selected by the user may be provided to the first memory 220 using an input device (e.g., a keyboard, a mouse, a remote controller, a touch pad, etc.) of the display device. In an exemplary embodiment, for example, the user may select a first over-driving data DOD1 that offsets the transit area of the first over-driving pattern, a second over-driving data DOD2 that offsets the transit area of the second over-driving pattern, and a third over-driving data DOD3 that offsets the transit area of the third over-driving pattern. In other exemplary embodiments, the over-driving data DOD that offsets the transit area TA may be selected in a manufacturing process of the display device. The selected over-driving data DOD in the manufacturing process may be provided to the first memory 220. For example, the first over-driving DOD1 that offsets the transit area of the first over-driving pattern, the second over-driving data DOD2 that offsets the transit area of the second over-driving pattern, and the third over-driving data DOD3 that offsets the transit area of the third over-driving pattern may be selected and provided to the first memory 220 in the manufacturing process of the display device.

The first memory 220 may store the over-driving data DOD. In an exemplary embodiment, for example, the first memory 220 may store the first over-driving data DOD1, the second over-driving data DOD2, and the third over-driving data DOD3. The first memory 220 may provide the first over-driving data DOD1 and the second over-driving data DOD2 to the first calculator 230 and provide the third over-driving data DOD3 to the second calculator 240.

The first calculator 230 may calculate parameters of a polynomial expression based on the over-driving data DOD and generate a reference line based on the polynomial expression. The first calculator may calculate the parameters of an equation 1 based on the over-driving data DOD.

>DOD−DPF=A(DCF)³+B(DCF)²+C(DCF)+D <Equation 1

Here, DOD is the over-driving data, DPF is the previous frame data, DCF is the present frame data, and A, B, C, D are parameters. The first calculator 230 may calculate the parameters of the equation 1 based on the first over-driving data DOD1, the second over-driving data DOD2, a predetermined first default data, and a predetermined second default data. The first calculator 230 may generate the reference line based on the polynomial expression. Here, the first default data and the second default data may be provided from the first memory 220. Alternatively, the first default data and the second default data may be stored in the first calculator 230 as default values or provided from an external device.

The second calculator 240 may calculate a moving amount based on the over-driving data DOD and generate the over-driving data lookup table LUT by moving the reference line based on the moving amount. The second calculator 240 may generate the over-driving data lookup table LUT based on an equation 2.

DOD−DPF=A(DCF−Δx)³+B(DCF−Δx)²+C(DCF−Δx)+D <Equation 2>

Here, DOD is the over-driving data, DPF is the previous frame data, DCF is the present frame data, Δx is the moving amount, and the A, B, C, D are parameters. The second calculator 240 may calculate the moving amount of the reference line provided from the first calculator 230 based on the third over-driving data DOD3 provided from the first memory 220 and generate the over-driving data lookup table LUT by moving the reference line based on the moving amount.

The second memory 250 may store the over-driving data lookup table LUT provided from the second calculator 240. The over-driving data lookup table stored in the second memory 250 may be provided to the timing controller 300.

As described above, the display device according to exemplary embodiments may provide an adjustable image to the user by selecting the over-driving data DOD based on the over-driving pattern and generating the over-driving lookup table LUT based on the over-driving data DOD. Thus, a display quality of the display device may improve.

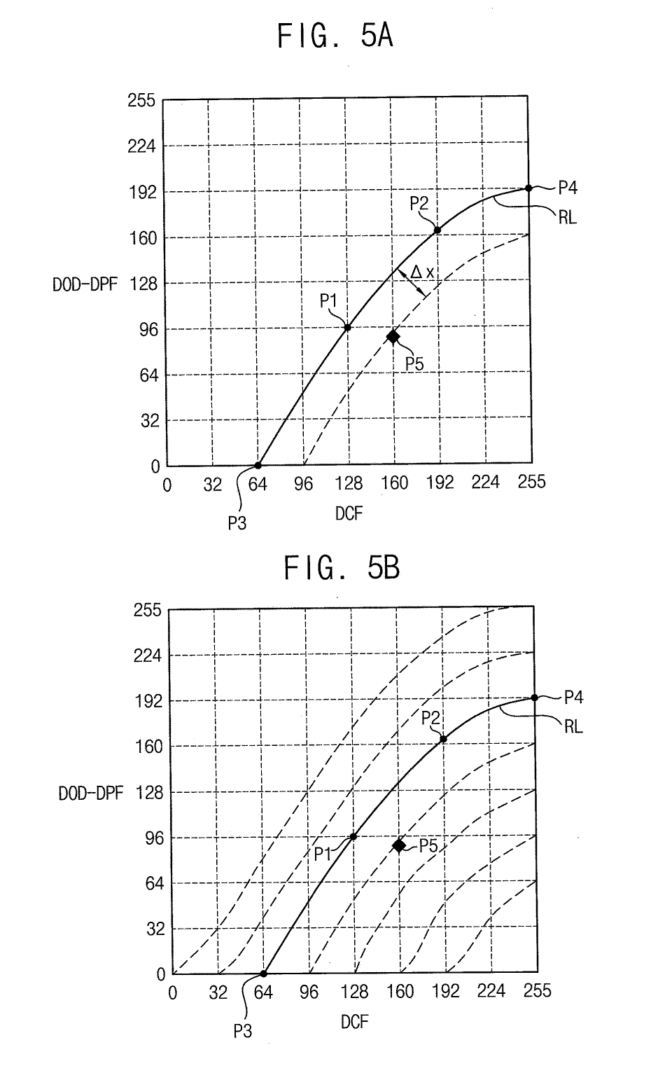

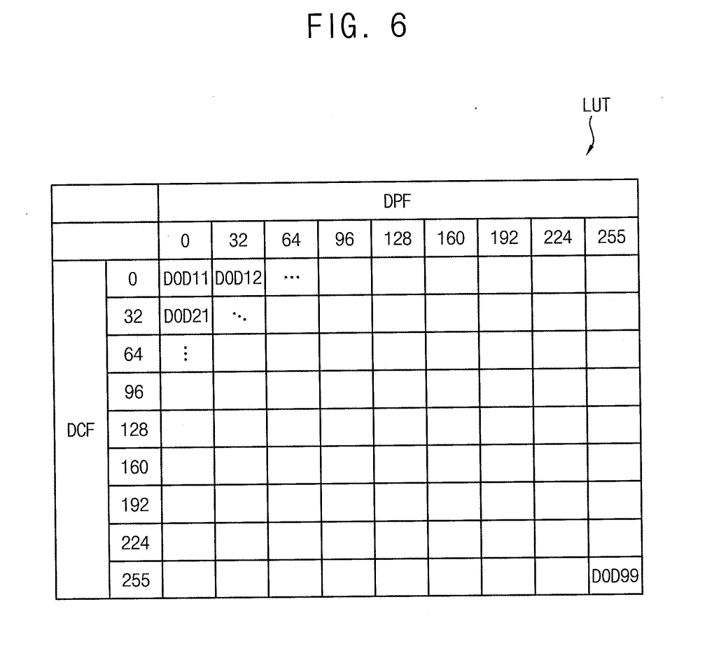

FIG. 4 is a graph illustrating a difference between over-driving data and previous frame data versus a present frame data for describing an operation of a first calculator included in the over-driver of FIG. 2, FIGS. 5A and 5B are graphs illustrating a difference between over-driving data and previous frame data versus a present frame data for describing an operation of a second calculator included in the over-driver of FIG. 2, and FIG. 6 is an exemplary embodiment of an over-driving lookup table for describing an operation of a second calculator included in the over-driver of FIG. 2.

The pattern generator 210 may generate the first over-driving pattern that includes the previous frame data DPF having the reference grayscale and the present frame data DCF having the first grayscale, the second over-driving pattern that includes the previous frame data DPF having the reference grayscale and the present frame data DCF having the second grayscale, and the third over-driving pattern that includes the previous frame data DPF having the third grayscale and the present frame data having the fourth grayscale.

The user may select the first over-driving data DOD1 that offsets the transit area by changing the data of the transit area when the first over-driving pattern is displayed on the display panel, the second over-driving data DOD2 that offsets the transit area by changing the data of the transit area when the second over-driving pattern is displayed on the display panel, and third over-driving data DOD3 that offsets the transit area by changing the data of the transit area when the third over-driving pattern is displayed on the display panel.

The first memory 220 may store the first over-driving data DOD1, the second over-driving data DOD2, and the third over-driving data DOD3.

The first calculator 230 may calculate the parameters of the equation 1 based on the first over-driving data DOD1, the second over-driving data DOD2, the predetermined first default data, and the predetermined second default data. Here, the first default data may be an over-driving data that is selected when the over-driving pattern that includes the previous frame data DPF and the present frame data DCF having the reference grayscale is displayed on the display panel, and the second default data may be an over-driving data that is selected when the over-driving pattern that includes the previous frame data DPF having the reference grayscale and the present frame data DCF having a maximum grayscale data is displayed on the display panel. The first default data may be the same with the reference grayscale because the previous frame data DPF and the present frame data DCF are the same with each other. The second default data may have the maximum grayscale that is the grayscale value of the present frame because the display device may not be over-driven over the maximum grayscale. In an exemplary embodiment, for example, the second default data may be 255 grayscale when the display device is driven by 8-bit data. Thus, the first default data and the second default data may have fixed values.

In an exemplary embodiment, for example, in the display device driven by 8-bit data, in a case that the reference grayscale is 64 grayscale, the first grayscale is 128 grayscale, the second grayscale is 192 grayscale, the third grayscale 96, and the fourth grayscale 160 grayscale, the pattern generator 210 may generate the first over-driving pattern that include the previous frame data having the 64 grayscale corresponding to the reference grayscale and the present frame data having the 128 grayscale corresponding to the first grayscale, the second over-driving pattern that includes the previous frame data having the 64 grayscale corresponding to the reference grayscale and the present frame data having the 192 grayscale corresponding to the second grayscale, and the third over-driving pattern that includes the previous frame data having the 96 grayscale corresponding to the third grayscale and the present frame data having the 160 grayscale corresponding to the fourth grayscale. The user may select the first over-driving data DOD1 that offsets the transit area of the first driving pattern, the second over-driving data DOD2 that offsets the transit area of the second driving pattern, and the third over-driving data DOD3 that offsets the transit area of the third driving pattern. The first memory 220 may store the first over-driving data DOD1, the second over-driving data DOD2, and the third over-driving data DOD3.

The first calculator 230 may calculate the parameters of the equation 1 based on the first over-driving data DOD1, the second over-driving data DOD2, the first default data, and the second default data stored in the first memory 220 and generate the reference line RL of FIG. 4 based on the equation 1. A x-axis represent a present frame data DCF and y-axis represent a difference between the over-driving data DOD and the previous frame data DPF in FIG. 4. a first coordinate P1 corresponds to the present frame data DCF having the 128 grayscale, and a second coordinate P2 corresponds to the present frame data DCF having 192 grayscale. a third coordinate P3 corresponds to the present frame data DCF (i.e., the first default data) having the 64 grayscale, and a fourth coordinate P4 corresponds to the present frame data DCF (i.e., the second default data) having the 255 grayscale.

The second calculator 240 may calculate the moving amount Δx of the reference line RL based on the third over-driving data DOD3 including a fifth coordinate P5. Referring to FIG. 5A, the second calculator may determine the moving amount Δx based on the reference line RL and the third over-driving data DOD3. Here, the moving amount Δx may include a moving amount of the x-axis and a moving amount of a y-axis. Referring to FIG. 5B, the second calculator 240 may move the reference line RL by the moving amount Δx. The second calculator 240 may generate the over-driving data lookup table LUT as described in FIG. 6 based on graphs described on FIG. 5B. The second calculator 240 may provide the over-driving lookup table LUT to the second memory 250.

As described above, the over-driver 200 included in the display device according to the exemplary embodiments may generate the over-driving data lookup table LUT for the dynamic capacitance compensation using the over-driving pattern without additional measuring device.

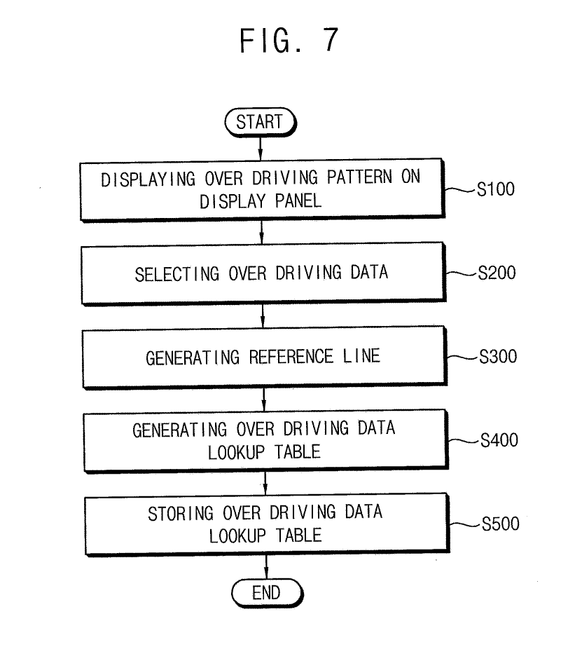

FIG. 7 is a flowchart illustrating an exemplary embodiment of a method of driving a display device according to the invention.

Referring to FIG. 7, a method of driving a display device according to exemplary embodiments may include displaying an over-driving pattern that moves to a predetermined direction on the display panel (S100), selecting an over-driving data that offsets a transit area of the over-driving pattern (S200), generating a reference line based on a polynomial expression generated based on the over-driving data (S300), generating an over-driving data lookup table LUT by moving the referenced line RL(S400), and storing the over-driving data lookup table LUT(S500).

The method of driving the display device may display the over-driving pattern on the display panel (S100). The over-driving pattern may move to the direction at a steady speed. The over-driving pattern may be determined considering a contrast sensitivity function. The over-driving pattern may include a previous data and a present data having different grayscales. The over-driving pattern may include the transit area where the previous frame data DPF is changed to the present frame data DCF. Here, at least three over-driving patterns may be displayed on the display panel as an example.

The method of driving the display device 100 may select the over-driving data that offsets the transit area of the over-driving pattern (S200). In some exemplary embodiments, a user may select the frame data having an adjustable grayscale value by changing the frame data of the transit area. The display device may receive the frame data as the over-driving data. In other exemplary embodiments, the over-driving data may be selected and stored in a manufacturing process of the display device. Here, at least three over-driving data corresponding to each of the over-driving patterns may be selected as an example.

The method of driving the display panel may generate the reference line based on the polynomial expression generated based on the over-driving data (S300). Parameters of the equation 1 may be calculated. The reference line may be generated based on the polynomial expression.

The method of driving the display device may generate the over-driving data lookup table LUT by moving the reference line RL (S400). A moving amount Δx of the reference line RL may be calculated based on the over-driving data DOD. The over-driving data lookup table LUT may be generated by moving the reference line RL by the moving amount Δx.

The method of driving the display device may store the over-driving data lookup table LUT (S500). The over-driving data lookup table LUT may be provided to the timing controller 300. The timing controller 300 may convert a first image data DATA1 to a second image data DATA2 based on the over-driving data lookup table LUT and provide the second image data DATA2 to a data driver 124.

The method of driving the display device may generate the first over-driving pattern that includes the previous frame data DPF having a reference grayscale and the present frame data DCF having a first grayscale, the second over-driving pattern that includes the previous frame data DPF having the reference grayscale and the present frame data DCF having a second grayscale, and the third over-driving pattern that includes the previous frame data DPF having a third grayscale and the present frame data DCF having a fourth grayscale.

The user may select the first over-driving data DOD1 that offsets the transit area by changing the grayscale value of the transit area when the first over-driving pattern is displayed on the display panel, the second over-driving data DOD2 that offsets the transit area by changing the grayscale value of the transit area when the second over-driving pattern is displayed on the display panel, and the third over-driving data DOD3 that offsets the transit area by changing the grayscale value of the transit area when the third over-driving pattern is displayed on the display panel. The first over-driving data DOD1, the second over-driving data DOD2, and the third over-driving data DOD3 may be stored in a memory.

The method of driving the display device may calculate the parameters of the equation 1 based on the first over-driving data DOD1, the second over-driving data DOD2, a predetermined first default data, and a predetermined second default data. The method of driving the display device may generate the polynomial expression of the equation 1 based on the parameters, and generate the reference line based on the polynomial expression.

The method of driving the display device may calculate the moving amount of the reference line based on the third over-driving data DOD3 and generate the over-driving data lookup table LUT by moving the reference line RL by the moving amount Δx.

The method of driving the display device may store the over-driving data lookup table LUT and provide the over-driving data lookup table LUT to the timing controller 300. The display device may provide a high display quality to the user by converting the first image data to the second image data based on the over-driving data lookup table LUT.

The inventive concept may be applied to a display device and an electronic device having the display device. In an exemplary embodiment, for example, the inventive concept may be applied to a computer monitor, a laptop, a digital camera, a cellular phone, a smart phone, a smart pad, a television, a personal digital assistant (“PDA”), a portable multimedia player (“PMP”), a MP3 player, a navigation system, a game console, a video phone, etc.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A display device comprising:
a display panel which includes data lines and gate lines; and
a display panel driver which drives the display panel,
wherein the display panel driver includes:
an over-driver which selects an over-driving data from an over-driving pattern which moves to a predetermined direction, generates a reference line based on a first polynomial expression generated based on the over-driving data, and generates an over-driving data lookup table by moving the reference line;
a data driver which outputs a data signal generated based on the over-driving data lookup table to the data line of the display panel; and
a gate driver which outputs a gate signal to the gate line of the display panel.

2. The display device of claim 1, wherein the over-driver includes:
a pattern generator which generates the over-driving pattern which includes previous frame data and present frame data having different grayscales, wherein the over-driving pattern includes a transit area where the previous frame data is changed to the present frame data;
a first memory which receives the over-driving data which offsets the transit area and store the over-driving data;
a first calculator which calculates parameters of the first polynomial expression based on the over-driving data and generates the reference line based on the first polynomial expression;
a second calculator which calculates a moving amount of the reference line based on the over-driving data and generates the over-driving data lookup table by moving the reference line as the moving amount; and
a second memory which stores the over-driving lookup table.

3. The display device of claim 2, wherein the first calculator calculates the parameters of the first polynomial expression:
DOD−DPF=A(DCF)³+B(DCF)²+C(DCF)+D,
based on the over-driving data and generates the reference line based on the first polynomial expression,
wherein DOD is the over-driving data, DPF is the previous frame data, DCF is the present frame data, and A, B, C, D are the parameters of the first polynomial expression.

4. The display device of claim 3, wherein the second calculator calculates the over-driving data lookup table based on the second polynomial expression:
DOD−DPF=A(DCF−Δx)³+B(DCF−Δx)²+C(DCF−Δx)+D,
wherein Δx is the moving amount.

5. The display device of claim 2, wherein the pattern generator generates a first over-driving pattern which includes the previous frame data having a reference grayscale and the present frame data having a first grayscale, and a second over-driving pattern which includes the previous frame data having the reference grayscale and the present frame data having a second grayscale.

6. The display device of claim 5, wherein the first memory stores a first over-driving data selected when the first over-driving pattern is displayed on the display panel, and a second over-driving data selected when the second over-driving pattern is displayed on the display panel.

7. The display device of claim 1, wherein a first calculator calculates parameters of the first polynomial expression based on a first over-driving data, a second over-driving data, a predetermined first default data, and a predetermined second default data.

8. The display device of claim 7, wherein the predetermined first default data is the over-driving data selected when the over-driving pattern which includes previous frame data and present frame data having a same reference grayscale is displayed on the display panel.

9. The display device of claim 7, wherein the predetermined second default data is the over-driving data selected when the over-driving pattern which includes previous frame data having a reference grayscale and present frame data having a maximum grayscale is displayed on the display panel.

10. The display device of claim 5, wherein the pattern generator further generates a third over-driving pattern which includes the previous frame data having a third grayscale and the present frame data having a fourth grayscale.

11. The display device of claim 10, wherein the first memory stores a third over-driving data selected when the third over-driving pattern is displayed on the display panel, and
wherein the second calculator calculates the moving amount based on the third over-driving data.

12. The display device of claim 1, wherein the over-driving data is selected by a user.

13. The display device of claim 1, wherein the over-driving data is input in a manufacturing process.

14. A method of driving a display device comprising:
displaying an over-driving pattern which moves to a predetermined direction on a display panel;
selecting an over-driving data which offsets a transit area of the over-driving pattern;
generating a reference line based on a first polynomial expression generated based on the over-driving data;
generating an over-driving data lookup table by moving the reference line; and
storing the over-driving data lookup table.

15. The method of claim 14, wherein the over-driving pattern includes previous frame data and present frame data having different grayscales, and
wherein the over-driving pattern includes the transit area where a previous frame data is changed to a present frame data.

16. The method of claim 14, wherein parameters of the first polynomial expression:
DOD−DPF=A(DCF)³+B(DCF)²+C(DCF)+D, is calculated based on the over-driving data,
wherein DOD is the over-driving data, DPF is previous frame data, DCF is present frame data, and A, B, C, D are the parameters of the first polynomial expression, and
wherein the reference line is generated based on the first polynomial expression.

17. The method of claim 16, wherein the over-driving data lookup table is generated based on a second polynomial expression:
DOD−DPF=A(DCF−Δx)³+B(DCF−Δx)²+C(DCF−Δx)+D,
wherein Δx is a moving amount.

18. The method of claim 14, further comprising:
generating the over-driving pattern includes:
generating a first over-driving pattern which includes previous frame data having a reference grayscale and present frame data having a first grayscale;
generating a second over-driving pattern which includes the previous data having the reference grayscale and the present frame data having a second grayscale; and
generating a third over-driving pattern which includes the previous data having a third grayscale and the present frame data having a fourth grayscale.

19. The method of claim 18, wherein selecting the over-driving data includes:
selecting the first over-driving data when the first over-driving pattern is displayed on a display panel;
selecting the second over-driving data when the second over-driving pattern is displayed on the display panel; and
selecting the third over-driving data when the third over-driving pattern is displayed on the display panel.

20. The method of claim 19, wherein parameters of the first polynomial expression are calculated based on the first over-driving data, the second over-driving data, a predetermined first default data, and a predetermined second default data, and
wherein a moving amount of the reference line is determined based on the third over-driving data.
